(19) United States
(12) Patent Application Publication
(10) Pub. No.: US 2025/0373605 A1
(43) Pub. Date: Dec. 4, 2025

(54) TECHNIQUES FOR SECURE DELIVERY OF SYSTEM INFORMATION

(71) Applicant: Lenovo (United States) Inc., Morrisville, NC (US)

(72) Inventors: Hyejung Jung, Northbrook, IL (US); Karthikeyan Ganesan, Kraiburg am Inn (DE); Razvan-Andrei Stoica, Witten (DE)

(21) Appl. No.: 19/306,932

(22) Filed: Aug. 21, 2025

(51) Int. Cl. H04L 9/40; H04L 27/26; H04W 72/23

(52) U.S. Cl. CPC H04L 63/0869; H04L 27/2607; H04W 72/23

(57) ABSTRACT

Various aspects of the present disclosure relate to techniques for secure delivery of system information (SI). A user equipment is configured to receive a first set of security parameters during registration with a first cell, receive first SI associated with a second cell, and monitor a physical downlink control channel (PDCCH) for second SI associated with the second cell based at least in part on the first set of security parameters.

### TECHNICAL FIELD

The present disclosure relates to wireless communications, and more specifically to techniques for secure delivery of system information (SI).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE) and methods of the present disclosure each have several innovative aspects, no single one of which is solely responsible for the desirable features disclosed herein.

A UE for wireless communication is described. The UE may be configured to, capable of, or operable to receive a first set of security parameters during registration with a first cell, receive first SI associated with a second cell, and monitor a physical downlink control channel (PDCCH) for second SI associated with the second cell based at least in part on the first set of security parameters.

A processor for wireless communication is described. The processor may be configured to, capable of, or operable to receive a first set of security parameters during registration with a first cell, receive first SI associated with a second cell, and monitor a PDCCH for second SI associated with the second cell based at least in part on the first set of security parameters.

A method for wireless communication performed by a UE is described. The method may be configured to, capable of, or operable to receive a first set of security parameters during registration with a first cell, receive first SI associated with a second cell, and monitor a PDCCH for second SI associated with the second cell based at least in part on the first set of security parameters.

An NE for wireless communication is described. The NE may be configured to, capable of, or operable to broadcast first SI of a cell and schedule, via a PDCCH, transmission of second SI of the cell on a physical downlink shared channel (PDSCH), wherein at least a portion of the PDCCH transmission and the PDSCH transmission for the second SI is based on parameters derived from a security context shared with registered UE.

A processor for wireless communication is described. The processor may be configured to, capable of, or operable to broadcast first SI of a cell and schedule, via a PDCCH, transmission of second SI of the cell on a PDSCH, wherein at least a portion of the PDCCH transmission and the PDSCH transmission for the second SI is based on parameters derived from a security context shared with registered UE.

A method for wireless communication performed by a NE is described. The method may be configured to, capable of, or operable to broadcast first SI of a cell and schedule, via a PDCCH, transmission of second SI of the cell on a PDSCH, wherein at least a portion of the PDCCH transmission and the PDSCH transmission for the second SI is based on parameters derived from a security context shared with registered UE.

### BRIEF DESCRIPTION OF THE DRAWINGS

FIG. 1 illustrates an example of a wireless communications system in accordance with aspects of the present disclosure.

FIG. 2A illustrates an example of an information element in accordance with aspects of the present disclosure.

FIG. 2B illustrates an example of an information element in accordance with aspects of the present disclosure.

FIG. 3 illustrates an example of a UE in accordance with aspects of the present disclosure.

FIG. 4 illustrates an example of a processor in accordance with aspects of the present disclosure.

FIG. 5 illustrates an example of an NE in accordance with aspects of the present disclosure.

FIG. 6 illustrates a flowchart of a method performed by a UE in accordance with aspects of the present disclosure.

FIG. 7 illustrates a flowchart of a method performed by an NE in accordance with aspects of the present disclosure.

### DETAILED DESCRIPTION

In some wireless communication systems, supporting 5G radio access technology, SI may be delivered (e.g., transmitted) to UE over one or more downlink channels, such as a physical broadcast channel (PBCH), a PDCCH, and/or a PDSCH. While UE-specific transmissions are typically protected through scrambling and other mechanisms associated with UE-specific identifiers (e.g., Cell Radio Network Temporary Identifier (C-RNTI), Configured Scheduling RNTI (CS-RNTI), Modulation and Coding Scheme Configuration RNTI (MCS-C-RNTI), Temporary Cell RNTI (TC-RNTI), Semi-Persistent Channel State Information RNTI (SP-CSI-RNTI), and so on), common or group-common transmissions used to deliver system information blocks (SIBs) are scrambled based on a physical cell identity (PCID). Because the PCID and the contents of the PBCH are broadcast, a malicious network entity can easily acquire information needed to intercept or generate (e.g., spoof) false SI or paging messages. As a result, the malicious network entity may broadcast false SI or paging messages, potentially deceiving UEs into initiating random access procedures toward an unauthorized (e.g., false, illegitimate) base station, thereby enabling extraction of sensitive UE information such as location and mobility data. To mitigate these vulnerabilities, the present disclosure provides mechanisms for securing the delivery of SI for 5G radio access technology, and among other suitable radio access technologies beyond 5G (e.g., 6G).

As described herein, to improve secure wireless communication (e.g., secure delivery of SI), a network (e.g., a base station) may associate SI delivery with a security context shared with a registered UE (e.g., a UE that has successfully completed network registration and established a valid security context with the network) within a security area. As used herein, a security area may refer to a logical region of a wireless communication network that encompasses one or more cells and/or tracking areas, within which a common security context is maintained and shared between NE and UE. The security area provides the scope over which a first set of security parameters, delivered securely during network registration, remains valid. When a UE moves between cells belonging to the same security area, the UE may continue to use the stored security context to derive cell-specific parameters (e.g., by hashing with cell identity, SSB frequency, or system frame number) for receiving and verifying system information (SI) of each new cell.

Portions of SI may continue to be broadcast by the network without protection to facilitate initial cell access, while other portions of SI may be scrambled, hashed, or otherwise protected using parameters derived from the security context. This enables the UE that has a valid security context (e.g., stored security context) to verify the integrity and authenticity of SI and thereby avoid connecting to unauthorized networks (e.g., rogue base stations).

Additionally, to improve secure wireless communication, a UE may generate secondary security parameters by combining the stored security context with cell-specific attributes, such as a cell identity, a synchronization signal frequency, or a system frame number. For example, the UE may input the cell identity, the frequency index of a synchronization signal block (SSB), and/or the current SFN as additional entropy into a hash function together with the stored security context. The output of the hash function provides cell-specific secondary security parameters that vary across cells and across time. These parameters may then be used to initialize scrambling sequences, select cyclic redundancy check (CRC) masks, determine interleaver offsets for control channel element (CCE) to resource element group (REG) mapping, or derive pseudo-random sequences for codeword scrambling. In this way, only UEs that possess the valid security context and apply the same cell-specific attributes can correctly descramble the protected downlink channels and acquire the secured system information. These parameters may then be applied to receive downlink channels and descramble information carrying protected SI. By integrating integrity protection and/or privacy protection directly into the physical channel layer, the present disclosure allows the UE to perform integrity checks prior to uplink transmissions, thereby reducing susceptibility to unauthorized networks (e.g., rogue base stations) while maintaining backward compatibility and efficient utilization of resources.

Aspects of the present disclosure are described in the context of a wireless communications system. Note that one or more aspects from different solutions may be combined.

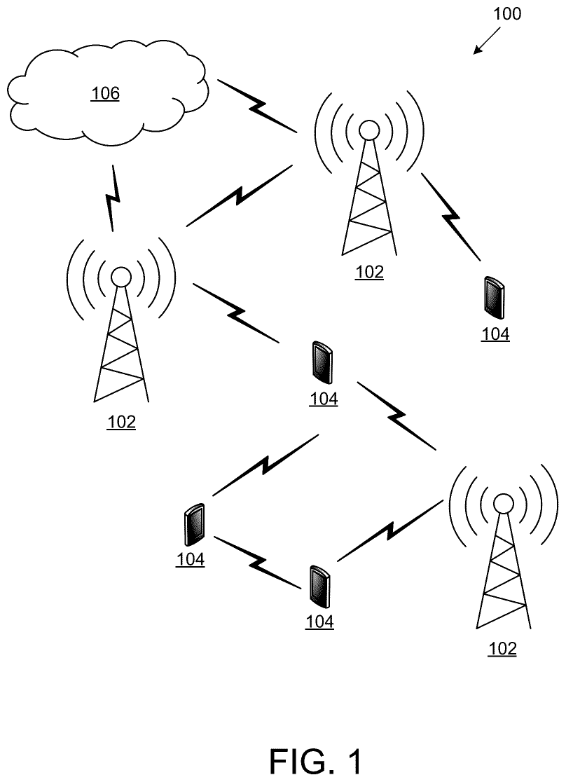

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHZ), and FR5 (114.25 GHz-300 GHz). In some implementations, the NEs 102 and the UEs 104 may perform wireless communications over one or more of the operating frequency bands. In some implementations, FRI may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FRI may be associated with one or multiple numerologies (e.g., at least three numerologies). For example, FRI may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communication system may, in some examples, may be a 5G network in which an NE 102 may transmit a PDCCH carrying downlink control information (DCI). For a UE-specific PDCCH (e.g., a PDCCH monitored within a UE-specific search space (USS)), the channel bits may be scrambled based at least in part on a C-RNTI and, if configured, a PDCCH demodulation reference signal (DMRS) scrambling identity assigned to a UE 104. These scrambling mechanisms ensure that the intended UE 104 is capable of decoding the PDCCH and recovering (e.g., decoding) the DCI. Additionally, the 5G network may support flexible control resource set (CORESET) allocation, flexible numerology, and beamforming for PDCCH, to provide further protection for UE-specific transmissions.

By contrast, for a common or group-common PDCCH (e.g., a PDCCH monitored within a common search space (CSS)), the channel bits may be scrambled with the PCID. Because the PCID and the contents of the PBCH are openly broadcast, the integrity of SI (e.g., SIB) delivery may be at risk. A PDCCH used for SI delivery, for example, a PDCCH with a CRC scrambled using a SI-RNTI, and the associated SIB content can therefore be compromised. An attacker can exploit this vulnerability by transmitting false SIB or paging messages, causing a UE 104 to attempt access to a false (e.g., rogue) base station and potentially disclose sensitive information, such as a location of the UE 104.

In the example of FIG. 1, one or more of the NE 102 or the UE 104 may support secure wireless communications, and particularly secure wireless communications (e.g., transmission and reception) of SI (e.g., SIBs) and/or paging messages in wireless communications systems supporting 5G radio access technology and among other suitable radio access technologies beyond 5G (e.g., 6G). By enabling one or more of the NE 102 or the UE 104 to utilizing security contexts shared between the NE 102 and the UEs 104, the present disclosure provides for protection of SI (e.g., SIBs) and/or paging messages while maintaining compatibility with existing radio access technologies and procedures.

In some cases, DCI may include various types of control information for UEs 104. Examples include downlink resource assignments and uplink grants, slot formats, and available resource block (RB) sets. DCI can also indicate channel occupancy time (COT) duration, search space set group switching, and time/frequency resources where a UE may assume no transmission is intended or where the UE 104 should cancel a corresponding UL transmission. Additional fields may provide transmit power control (TPC) commands, availability of soft resources for IAB-MT, or power saving information outside discontinuous reception (DRX) Active Time. Further examples include a paging early indication, tracking reference signal (TRS) availability indication, aperiodic beam indication and associated time resources for network controlled repeater (NCR) operation, as well as activation or deactivation of discontinuous transmission (DTX) and/or DRX configurations for one or more serving cells. DCI may also signal a network energy saving (NES) mode indication of a primary cell for one or more UEs 104.

According to 3GPP TS 38.211 “NR; Physical channels and modulation,” V18.6.0 (2025 Apr. xx) and 3GPP TS 38.213 “NR; Physical layer procedures for control,” V18.6.0 (2025 Apr. 04) (both incorporated herein by reference), a PDCCH consists of one or more control channel elements (CCEs), with supported aggregation levels of 1, 2, 4, 8, or 16 CCEs. A CORESET is defined in both the frequency and time domains, comprising N_{RB}^{CORESET} resource blocks and N_{symb}^{CORESET}∈{1, 2, 3} OFDM symbols. Each CCE consists of six resource element groups (REGs), where a REG corresponds to one RB in one OFDM symbol. REGs within a CORESET are numbered sequentially in time-first order, beginning with the lowest RB in the first symbol.

A UE 104 may be configured with multiple CORESETs, with each CORESET associated with a single CCE-to-REG mapping. The mapping can be interleaved or non-interleaved and is described using REG bundles. A REG bundle is defined as a set of REGs of size L, and a CCE consists of a fixed number of REG bundles as determined by an interleaver function.

Each CORESET configuration provides the UE 104 with parameters such as a CORESET index, a DMRS scrambling initialization value (pdcch-DMRS-ScramblingID), and precoder granularity (either sameAsREG-bundle or allContiguousRBs). The CORESET also specifies the number of symbols, frequency-domain resources, and CCE-to-REG mapping type. Additional parameters include antenna port quasi co-location information (via TCI-State) and information for the presence or absence of a transmission configuration indication (TCI) field for certain DCI formats.

Frequency domain resources for each CORESET are signaled using a bitmap. If not associated with a search space set configured with freqMonitorLocations, the bitmap maps one-to-one with non-overlapping groups of six consecutive PRBs. Indexing of PRBs in the downlink (DL) bandwidth part (BWP) depends on the starting RB position N_{BWP}^{start} any offset N_{RB}^{offset}. For monitored PDCCHs, the block of encoded channel bits is scrambled, quadrature phase shift keying (QPSK)-modulated, scaled, and then mapped to resource elements in frequency-first, time-later order, excluding REs reserved for PDCCH DMRS.

Further, under 3GPP TS 38.213, a UE 104 monitors a set of PDCCH candidates in one or more CORESETs on an active DL BWP of each serving cell. A search space set can be a CSS or a USS. USSs (configured with searchSpaceType=ue-Specific) are used for DCI formats with CRC scrambled by UE-specific identifiers such as C-RNTI, MCS-C-RNTI, SP-CSI-RNTI) or CS-RNTI, and are collectively referred to as unicast DCI formats.

If a UE 104 has not been provided a Type3-PDCCH CSS, Type1A-PDCCH CSS, or a USS, but has a C-RNTI and a Type1-PDCCH CSS, the UE 104 monitors PDCCH candidates for DCI formats 0_0 and 1_0 with CRC scrambled by the C-RNTI. When a UE 104 is configured with one or more search space sets (e.g., searchSpaceZero, searchSpaceSIB1, searchSpaceOtherSystemInformation, pagingSearchSpace, or ra-SearchSpace) and has a valid C-RNTI, MCS-C-RNTI, or CS-RNTI, it monitors PDCCH candidates for DCI formats 0_0 and 1_0 scrambled with those identifiers, in addition to monitoring for common RNTIs such as SI-RNTI, random access RNTI (RA-RNTI), MsgB-RNTI, or paging RNTI (P-RNTI).

If the UE 104 is configured with search space sets such as searchSpaceZero, searchSpaceSIB1, searchSpaceOtherSystemInformation, pagingSearchSpace, pei-SearchSpace, or ra-SearchSpace, and receives an RNTI such as SI-RNTI, P-RNTI, paging early indication RNTI (PEI-RNTI), RA-RNTI, MsgB-RNTI, slot format indication RNTI (SFI-RNTI), interruption RNTI (INT-RNTI), or transmit power control RNTIs (TPC-RNTIs) (for PUSCH, PUCCH, or sounding reference signal (SRS)), the UE 104 processes no more than one DCI format with CRC scrambled by that RNTI per slot.

In some examples, during a registration procedure to a network, a UE 104 may receive a security context associated with one or more tracking areas, RAN areas, or a broader security area. The security context may comprise parameters related to hashing, scrambling, and other integrity protection functions, and may be delivered in an encrypted and integrity-protected manner as part of an access stratum (AS) setup. For subsequent mobility, if the UE 104 encounters a cell that belongs to an area for which the UE 104 retains a valid security context, the network may broadcast a minimum set of SI without privacy protection. This minimum SI may include only those parameters necessary for any UE 104 to perform initial access to the cell, such as basic cell selection and re-selection criteria, paging configuration, and random access configuration. At the same time, the network may broadcast a hashed portion of the minimum SI with privacy protection, wherein the hashing and scrambling are based on the shared security context.

If the UE 104, operating in radio resource control (RRC) idle mode, reselects to the cell, it may receive both the unprotected minimum SI and the hashed portion with privacy protection. Using the security context, the UE 104 may then perform an integrity check of the protected portion of the SI. Because this hashed portion may include parameters critical to cell access, such as random access (RA) configuration or paging configuration, the UE 104 can verify that the received SI is legitimate. This process may prevent the UE 104 from attempting access to a false base station, thereby reducing the risk of location leakage or other exposure of private information.

In other examples, the network may broadcast only part of the minimum SI without protection and transmit the remaining portion of the minimum SI with protection. The protected portion may be based on the shared security context associated with the relevant tracking area or security area. In this case, only UEs 104 that possess the up-to-date security context may be able to decode the complete SI and initiate a valid connection request. UEs 104 that lack the necessary security context or whose context has expired may be unable to decode the protected portion and therefore perform cell reselection to another candidate cell.

In another variation, the network may broadcast a partial minimum SI without protection and transmit the remaining minimum SI on demand. For example, the remaining portion may be sent in response to at least one UE 104 being paged and/or upon receipt of a UE 104 request for SI transmission. In such cases, the partial SI broadcast without protection may include a resource configuration that allows UEs 104 to request the transmission of additional SI. This approach may reduce unnecessary SI transmissions and conserve network energy, while still supporting UEs 104 that do not have a valid security context.

For a given SI transmission window associated with one or more paging occasions, the network may adapt its transmission behavior based on UE 104 capabilities. If at least one UE 104 that does not support privacy-protected SI delivery is paged, the network may transmit the remaining SI without protection. If, on the other hand, all UEs 104 paged in that window support SI protection, the network may transmit the remaining SI with protection. This approach allows the network to balance compatibility with UEs 104 not capable of receiving protected SI against security benefits for UEs 104 capable of receiving the protected SI.

In some implementations, the SI request resource configuration may define two subsets of resources: a first subset for UEs 104 supporting protected SI delivery (e.g., UEs 104 that hold a valid security context and/or can receive and decode PDCCH/PDSCH based on the security context) and a second subset for UEs 104 that do not support SI protection. During a given SI transmission window, if the network detects at least one SI request on a resource from the second subset, the network may transmit the remaining SI without protection. If all detected requests fall within the first subset, the network may transmit the remaining SI with protection. A UE 104 configured for protected SI delivery may identify whether the transmission is protected by blind decoding of the PDCCH, for example by attempting to descramble the CRC of the DCI using different candidate sequences.

In some other examples, the network may broadcast minimum SI without protection and, in addition, broadcast a hashed portion of the minimum SI with protection in a designated SI transmission window. This may occur, for example, if at least one UE 104 supporting privacy-protected SI delivery is paged, or if the network detects an SI request transmitted using resources configured for protected delivery. The hashing and scrambling may be based on the security context shared with the UE 104 during its registration procedure. In this manner, UEs 104 with valid security context can verify the authenticity of SI and avoid accessing a false base station. At the same time, the network can reduce overhead by transmitting protected SI portions only when needed.

In one example implementation, while a UE 104 is connected to a first cell and performing registration, it may receive a first set of security parameters (e.g., hashing parameters) associated with a tracking area, RAN area, or security area via an encrypted and integrity-protected message. When the UE 104 subsequently detects a second cell, it may receive the first SI of that cell and perform reselection based on PBCH/SSB and the received SI. If the first SI indicates that the second cell belongs to an area for which the UE 104 holds valid security parameters, the UE 104 may generate a second set of security parameters by applying a hash function (e.g., SHA-256) to at least part of the first set. In some examples, the UE 104 may also include cell-specific attributes such as the PCID, the frequency location of SSBs (e.g., in terms of absolute radio frequency channel number (ARFCN)), and/or the system frame number (SFN) in the hash computation. In one variation, the cell identity used in the hash is derived from synchronization signals; in another, it is provided as an RRC parameter in the first SI. The UE 104 may then monitor a PDCCH for delivery of second SI of the cell using the generated second set of security parameters.

In some implementations, the network may also provide the UE 104 with a security context validity timer. The UE 104 may start this timer upon registration and initiate a new registration procedure when the timer expires, thereby obtaining an updated first set of security parameters. If no validity timer is provided, the UE 104 may instead rely on periodic or mobility-triggered registration updates, i.e., the UE 104 initiates a new registration procedure when one or more update conditions is met, e.g. the UE 104 detects that a current tracking area identity (TAI) is not in the list of tracking areas that the UE 104 previously registered in the AMF, or a periodic registration updating timer expires, and receives the updated first set of security parameters.

The PBCH and/or the first SI may also indicate whether second SI will be transmitted and may include a configuration for PDCCH monitoring of second SI. In one case, the first SI may be delivered via a PDCCH scrambled with an SI-RNTI and PCID, and a corresponding PDSCH scrambled with sequences initialized by the SI-RNTI and PCID. In contrast, the second SI may be delivered via a PDCCH scrambled with one or more parameters of the second set of security parameters, and a corresponding PDSCH scrambled with sequences initialized by another subset of those parameters. For the second PDCCH, channel bits, CRC bits, CCE-to-REG interleaver mappings, and CCE indexes of a candidate PDCCH may each be scrambled or shifted based on distinct parameters derived from the second security set. Similarly, PDSCH codewords carrying second SI may be scrambled using sequences initialized from security-derived parameters.

In certain implementations, the second set of parameters may be generated using a hash function such as SHA-256, which produces a fixed-length 256-bit (32-byte) output. Portions of this output may then be allocated to scramble CRC parity bits, to initialize a scrambling sequence for scrambling PDCCH channel bits, to determine CCE-to-REG mapping interleaver functions, to determine CCE indexes for PDCCH candidates, and to initialize a scrambling sequence for scrambling a PDSCH codeword(s). By distributing the hash-derived bits across multiple layers of the physical channel processing chain, the network can ensure that second SI delivery is tightly bound to the shared security context.

In some examples, The CRC parity bits

$${\{ {b}_{k} \}}_{k = 0}^{k = 23}$$

or the DCI in the second PDCCH are scrambled with the 24 bits xₒ₁, Xₒ₁₊₁, . . . , Xₒ₁₊₂₃ of the output sequence resulting from hashing the part of the first set of security parameters, where x₀ corresponds to the most significant bit (MSB) and the bit position offset O₁ is predetermined or included in the first set of security parameters or derived/determined based on the first set of security parameters, to form the sequence of bits c₀, c₁, c₂, c₃, . . . , c₂₃. The relation between cₖ and bₖ is cₖ=(bₖ+xₒ₁₊ₖ) mod 2 for k=0, 1, 2, . . . , 23.

Additionally, in some examples, for the second PDCCH, a block of bits b(0), . . . , b(M_{bit}−1) resulting from encoding, where M_{bit} is the number of bits transmitted on the second PDCCH, is scrambled prior to modulation, resulting in a block of scrambled bits \tilde{b}(0), . . . , \tilde{b}(M_{bit}−1) according to \tilde{b}(i)=(b(i)+c(i)) mod 2, where c(i) is a scrambling sequence (i.e. pseudo-random sequence such as a length-31 Gold sequence). The scrambling sequence generator is initialized with cᵢₙᵢₜ=(N_{ID1}·2¹⁶+n_{ID2}) mod 2³¹, where N_{ID1}·∈{0, 1, . . . , 65535} and n_{ID2}∈{0, 1, . . . , 65535}, and n_{ID1} is a value determined by 16 bits xₒ₂, xₒ₂₊₁, . . . >xₒ₂₊₁₅ of the output sequence of hashing, and n_{ID2} is a value determined by another 16 bits xₒ₃, xₒ₃₊₁, . . . , xₒ₃₊₁₅ of the output sequence of hashing, where the bit position offsets O₂ and O₃ are predetermined or included in the first set of security parameters or derived/determined based on the first set of security parameters.

Further, for the second PDCCH, an interleaver for CCE-to-REG mapping is defined as

$$f ( x ) = ( rC + c + {n}_{shift} ) mod ( {N}_{REG}^{CORESET} / L )$$

where x=cR+r, r=0, 1, . . . , R−1, c=0, 1, . . . , C−1, and

$$C = {N}_{REG}^{CORESET} / ( LR )$$

and where

$$L ∈ \{ 2 , 6 \} for {N}_{symb}^{CORESET} = 1 and L ∈ \{ {N}_{symb}^{CORESET} , 6 \} for {N}_{symb}^{CORESET} ∈ \{ 2 , 3 \} ,$$

and R∈{2, 3, 6} and n_{shift}∈{0, 1, . . . , 255}, n_{shift} is a value determined by 8 bits xₒ₄, xₒ₄₊₁, . . . , xₒ₄₊₇ of the output sequence of hashing, where the bit position offset O₄ and interleaver parameters L (a REG bundle size) and R (an interleaver size) are predetermined or included in the first set of security parameters or derived/determined based on the first set of security parameters.

Regarding the second PDCCH, for a search space set s associated with CORESET p, CCE indexes for aggregation level L corresponding to PDCCH candidate mₛ^{(L)} of the search space set in slot n_{s,f}^{μ}for an active DL BWP of the second cell, are given by

$$L \cdot \{ ( {Y}_{p , {n}_{s , f}^{μ}} + ⌊ \frac{{m}_{s}^{( L )} \cdot {N}_{CCE , p}}{L \cdot {M}_{s , max}^{( L )}} ⌋ ) mod ⌊ {N}_{CCE , p} / L ⌋ \} + i where {Y}_{p , {n}_{s , f}^{μ}} = ( {A}_{p} \cdot {Y}_{p , {n}_{s , f}^{μ} - 1} ) mod D ,$$

Y_{p,-1}=n_{ID3}, Aₚ=39827 for p mod3=0, Aₚ=39829 for p mod3=1, Aₚ=39839 for p mod3=2, and D=65537, where n_{ID3}∈{0, 1, . . . , 65535} and n_{ID3} is a value determined by 16 bits x₀₅, x₀₅₊₁, . . . , x₀₅₊₁₅ of the output sequence of hashing, where the bit position offset O₅ is predetermined or included in the first set of security parameters or derived/determined based on the first set of security parameters; i=0, . . . , L−1; N_{CCE,p} is the number of CCEs, numbered from 0 to N_{CCE,p}−1, in CORESET p; and

$${m}_{s}^{( L )} = 0 , … , {M}_{s}^{( L )} - 1 ,$$

where

$${M}_{s}^{( L )}$$

is the number of PDCCH candidates a UE 104 is configured to monitor for aggregation level L of a search space set s for the second cell.

In the second PDSCH, for each codeword q, the UE 104 assumes block of bits

$${b}^{( q )} ( 0 ) , … , {b}^{( q )} ( {M}_{bit}^{( q )} - 1 ) ,$$

where

$${M}_{bit}^{( q )}$$

is the number of bits in codeword q transmitted on the second PDSCH, are scrambled prior to modulation, resulting in a block of scrambled bits

$${\tilde{b}}^{( q )} ( 0 ) , … , {\tilde{b}}^{( q )} ( {M}_{bit}^{( q )} - 1 )$$

according to \tilde{b}^{(q)}(i)=(b^{(q)}(i)+c^{(q)}(i)) mod 2 where c^{(q)}(i) is a scrambling sequence (i.e. pseudo-random sequence such as a length-31 Gold sequence). The scrambling sequence generator is initialized with cᵢₙᵢₜ=N_{ID4}·2¹⁵+q·2¹⁴+n_{ID5} where n_{ID4}∈{0, 1, . . . , 65535} and n_{ID5} € {0, 1, . . . , 1023} and n_{ID4} is a value determined by 16 bits xₒ₆, xₒ₆₊₁, . . . , xₒ₆₊₁₅ of the output sequence of hashing, and n_{ID5} is a value determined by another 10 bits xₒ₇, xₒ₇₊₁, . . . >xₒ₇₊₉ of the output sequence of hashing, where the bit position offsets O₆ and O₇ are predetermined or included in the first set of security parameters or derived/determined based on the first set of security parameters.

In one implementation, the first SI of a second cell may include all of the minimum SI required for access to that cell, except for information already provided in the MIB/PBCH of the second cell. Such first SI may include, for example, cell-specific Layer-1 (L1) and Layer-2 (L2) configuration parameters, including but not limited to a paging configuration and a RA configuration. In this case, the second SI may comprise at least hashed bits corresponding to at least a portion of the RA configuration of the second cell.

Upon detecting a PDCCH carrying DCI for the second SI, the UE 104 may receive a corresponding PDSCH containing the second SI, decode the PDSCH based on a second identity derived from the security context, and thereby acquire the second SI. If the hashed portion of the RA configuration in the second SI matches with a locally generated hash computed from the RA configuration of the first SI, the UE 104 may determine that the RA configuration in the first SI is valid and may initiate an RA procedure in accordance with that configuration upon receipt of a paging message and/or upon arrival of mobile-originated traffic. If the verification fails, the UE 104 may reacquire SI for the second cell and/or perform reselection to another candidate cell.

In another implementation, or in addition to the above, the second SI may comprise hashed bits corresponding to at least a portion of the paging configuration of the second cell. In such a case, the UE 104 may acquire the second SI by detecting a PDCCH scrambled with the second identity and successfully decoding the corresponding PDSCH. If the hashed portion of the paging configuration contained in the second SI matches a locally generated hash of the paging configuration contained in the first SI, the UE 104 may determine that the paging configuration of the first SI is valid and begin monitoring PDCCH paging messages according to that configuration.

Alternatively, or in addition, the UE 104 may begin monitoring a PDCCH for delivery of the second SI of the second cell in response to certain triggers, such as receiving a paging message, detecting paging DCI during its paging occasion, or transmitting a SI request. This approach may provide additional flexibility in how the second SI is acquired and validated by the UE 104.

In another implementation, the first SI of the second cell may contain a subset of the minimum SI, such as cell selection or reselection criteria and cell access-related information, including a tracking area code (TAC), a RAN area code, or a security area code. In this case, the second SI may include the remaining minimum SI, such as the RA configuration, which may be absent from both the first SI and the MIB/PBCH. If none of the tracking area, RAN area, or security area identifiers indicated in the first SI matches a stored list maintained by the UE 104, the UE 104 may determine not to select the second cell. However, if the UE 104 does select the second cell, it may monitor the PDCCH for delivery of the second SI based on the second set of security parameters derived from the shared security context and thereby acquire the remaining minimum SI.

In yet another implementation, the first SI may contain a partial set of minimum SI, such as cell selection/reselection criteria, cell access information (e.g., TAC, RAN area code, or security area code), a paging configuration, and a resource configuration for transmitting an SI request. In this case, the second SI may include the remaining minimum SI, such as the RA configuration and other L1/L2 configuration parameters specific to the cell. The UE 104 may start to monitor the PDCCH for delivery of the second SI in response to receiving a paging message, detecting paging DCI during its paging occasion, or transmitting an SI request. If none of the identifiers in the first SI matches the UE's stored list of tracking areas, RAN areas, or security areas, the UE 104 may still monitor the PDCCH for delivery of the remaining minimum SI, but without applying security parameters. In scenarios where the UE has previously received a first set of security parameters and generated a second set based on those parameters, the UE 104 may acquire the remaining minimum SI either without using security parameters or based on the generated second set.

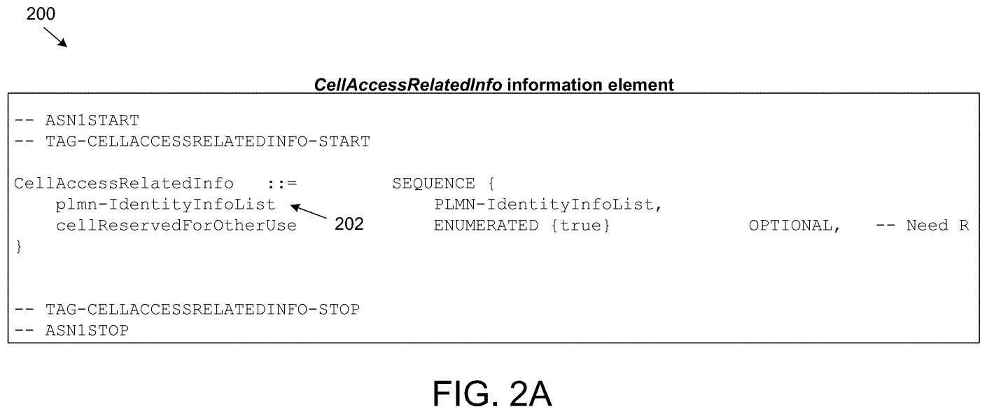

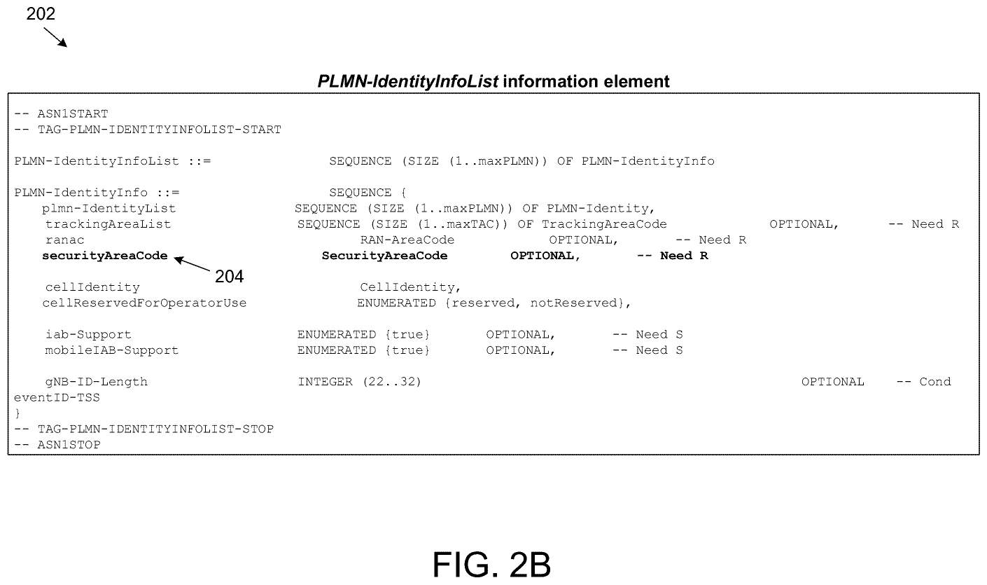

FIG. 2A illustrates an example of a CellAccessRelatedInfo information element (IE) 200, in accordance with aspects of the present disclosure. In some examples, the CellAccessRelatedInfo IE 200 is included in the first SI of the second cell. The CellAccessRelatedInfo IE 200 includes, among other fields, a PLMN-Identity InfoList IE 202, as shown in FIG. 2B. The table below describes the fields within the CellAccessRelatedInfo IE 200:

CellAccessRelatedInfo field descriptions

cellReservedForOtherUse
Indicates whether the cell is reserved. The field is
applicable to all PLMNs. This field is ignored by
IAB-MT and NCR-MT for cell barring determination.
plmn-IdentityInfoList
The plmn-IdentityInfoList is used to configure a
set of PLMN-IdentityInfo elements. Each of those elements
contains a list of one or more public land mobile network (PLMN)
Identities and additional information associated
with those PLMNs. A PLMN-identity can be included only once,
and in only one entry of the PLMN-IdentityInfoList. The PLMN
index is defined as b1 + b2 + . . . + b(n − 1) + i
for the PLMN included at the n-th entry of PLMN-IdentityInfoList
and the i-th entry of its corresponding PLMN-IdentityInfo,
where b(j) is the number of PLMN-Identity entries
in each PLMN-IdentityInfo, respectively.

FIG. 2B illustrates an example of a PLMN-IdentityInfoList IE 202, in accordance with aspects of the present disclosure. Within this IE, a parameter security AreaCode 204 may be provided to indicate the security area to which the second cell belongs. The first set of security parameters delivered to the UE 104 may be associated with the security area indicated by the security AreaCode parameter. The table below describes the fields within the PLMN-Identity InfoList IE 202:

PLMN-IdentityInfo field descriptions

cellReservedForOperatorUse
Indicates whether the cell is reserved for operator use
(per PLMN). This field is ignored by IAB-MT and NCR-MT.
cellIdentity
Unambiguously identify a cell within a PLMN.
gNB-ID-Length
Indicates the length of the gNB ID out of the 36-bit long.
This field is always present if the mobileIAB-Support is broadcasted.
iab-Support
This field combines both the support of
IAB and the cell status for IAB.
If the field is present, the cell supports IAB and the
cell is also considered as a candidate for cell
(re)selection for IAB-node; if the field is absent, the
cell does not support IAB and/or the cell is barred for IAB-node.
This field is absent if mobileIAB-Cell is broadcasted in the cell.
mobileIAB-Support
This field indicates the support of mobile IAB and whether the
cell can be considered as a candidate for cell (re)selection
for mobile IAB-node. This field is absent if mobileIAB-Cell
is broadcasted in the cell. If the field is absent,
the cell is barred for mobile IAB-node.
trackingAreaList
List of Tracking Areas to which the cell indicated by
cellIdentity field belongs. Total number of different tracking
area codes (TACs) across different PLMN-IdentityInfos shall
not exceed maxTAC. The absence of the field indicates
that the cell only supports primary secondary cell (PSCell)/
secondary cell (Scell) functionality per PLMN.
TrackingAreaCode
Identify a tracking area within a scope of a PLMN.
RAN-AreaCode
Identify a RAN area within a scope of a tracking area.
securityAreaCode
Identify a security area within a scope of a PLMN,
where cells in the security area shares security
context used for secure SI delivery.

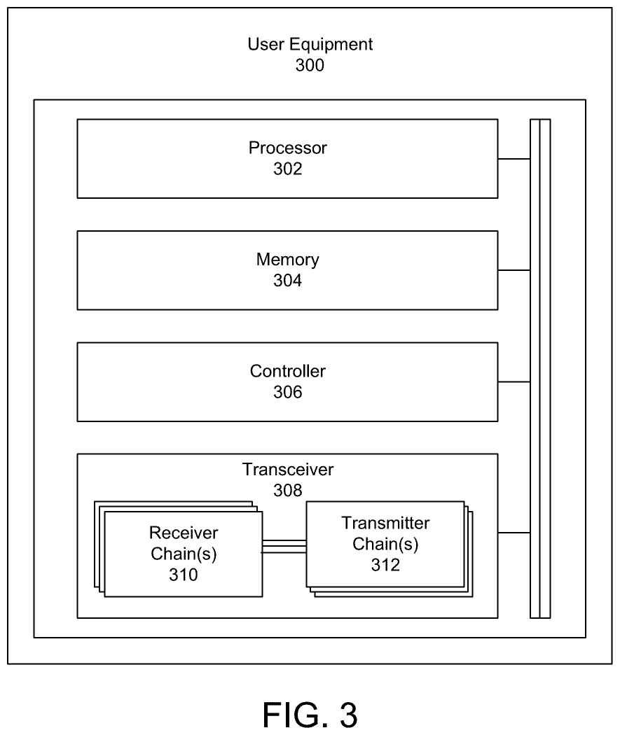

FIG. 3 illustrates an example of a UE 300 in accordance with aspects of the present disclosure. The UE 300 may include a processor 302, a memory 304, a controller 306, and a transceiver 308. The processor 302, the memory 304, the controller 306, or the transceiver 308, or various combinations thereof or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, or the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a central processing unit (CPU), an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions that, when executed by the processor 302, cause the UE 300 to perform various functions described herein. The code may be stored in a non-transitory computer-readable medium such the memory 304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 302 and the memory 304 coupled with the processor 302 may be configured to cause the UE 300 to perform one or more of the UE functions described herein (e.g., executing, by the processor 302, instructions stored in the memory 304). Accordingly, the processor 302 may support wireless communication at the UE 300 in accordance with examples as disclosed herein.

In some examples, the UE 300 is configured to receive a first set of security parameters during registration with a first cell, receive first SI associated with a second cell, and monitor a PDCCH for second SI associated with the second cell based at least in part on the first set of security parameters.

In some examples, the UE 300 is configured to generate a second set of security parameters based on the at least part of the first set of security parameters and monitor the PDCCH for the second SI using the second set of security parameters.

In some examples, the UE 300 is configured to generate the second set of security parameters by hashing the first set of security parameters with at least one of a cell identity associated with the second cell, a frequency of a synchronization signal block associated with the second cell, or a system frame number associated with the second cell.

In some examples, the UE 300 is configured to descramble a CRC of DCI for the second SI using at least one of the second set of security parameters. In some examples, the UE 300 is configured to monitor a PDCCH according to an interleaver for CCE to REG mapping, the interleaver being determined using at least one of the second set of security parameters, wherein a CCE comprises a first number of REGs and a REG comprises a second number of resource elements.

In some examples, the UE 300 is configured to receive a PDSCH for the second SI, the PDSCH comprising codewords that have been scrambled based on at least one of the second set of security parameters and descramble the codewords based on the at least one of the second set of security parameters.

In some examples, the second SI comprises hashed bits of a random access configuration or paging configuration, and the UE 300 is configured to verify an integrity of the first SI by comparing the hashed bits with locally generated hashed bits.

In some examples, the UE 300 is configured to initiate a random access procedure in response to, at least in part, the hashed bits matching the locally generated hashed bits. In some examples, the UE 300 is configured to monitor the PDCCH for the second system information in response to receiving a paging message or transmitting an SI request.

In some examples, the UE 300 is configured to start a timer in response to the registration and initiate a re-registration procedure upon expiry of the timer to obtain an updated first set of security parameters.

The controller 306 may manage input and output signals for the UE 300. The controller 306 may also manage peripherals not integrated into the UE 300. In some implementations, the controller 306 may utilize an operating system (OS) such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas for receiving the signal over the air or wireless medium. The receiver chain 310 may include at least one amplifier (e.g., a low-noise amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding/processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

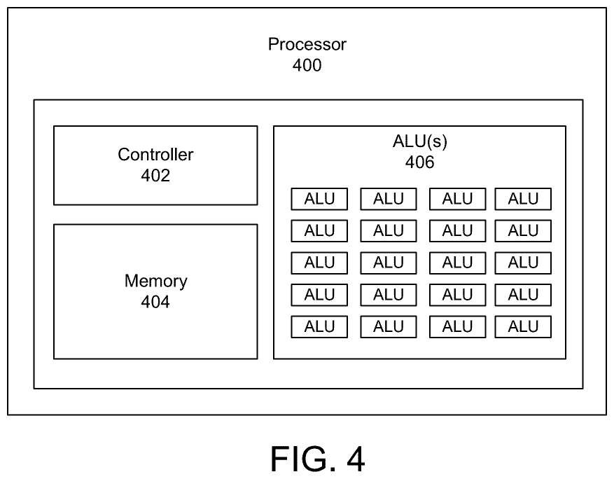

FIG. 4 illustrates an example of a processor 400 in accordance with aspects of the present disclosure. The processor 400 may be an example of a processor configured to perform various operations in accordance with examples as described herein. The processor 400 may include a controller 402 configured to perform various operations in accordance with examples as described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 402 may be configured to manage and coordinate various operations (e.g., signaling, receiving, obtaining, retrieving, transmitting, outputting, forwarding, storing, determining, identifying, accessing, writing, reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory address of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage flow of data within the processor 400. The controller 402 may be configured to control transfer of data between registers, arithmetic logic units (ALUs), and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

In various examples, the processor 400 may support wireless communication of a UE, in accordance with examples as disclosed herein. In other examples, the processor 400 may support wireless communication of a RAN entity, in accordance with examples as disclosed herein.

In one example, a processor 400 is configured to receive a first set of security parameters during registration with a first cell, receive first SI associated with a second cell, and monitor a PDCCH for second SI associated with the second cell based at least in part on the first set of security parameters.

In some examples, the processor 400 is configured to generate a second set of security parameters based on the at least part of the first set of security parameters and monitor the PDCCH for the second SI using the second set of security parameters.

In some examples, the processor 400 is configured to generate the second set of security parameters by hashing the first set of security parameters with at least one of a cell identity associated with the second cell, a frequency of a synchronization signal block associated with the second cell, or a system frame number associated with the second cell.

In some examples, the processor 400 is configured to descramble a CRC of DCI for the second SI using at least one of the second set of security parameters. In some examples, the processor 400 is configured to monitor a PDCCH according to an interleaver for CCE to REG mapping, the interleaver being determined using at least one of the second set of security parameters, wherein a CCE comprises a first number of REGs and a REG comprises a second number of resource elements.

In some examples, the processor 400 is configured to receive a PDSCH for the second SI, the PDSCH comprising codewords that have been scrambled based on at least one of the second set of security parameters and descramble the codewords based on the at least one of the second set of security parameters.

In some examples, the second SI comprises hashed bits of a random access configuration or paging configuration, and the processor 400 is configured to verify an integrity of the first SI by comparing the hashed bits with locally generated hashed bits.

In some examples, the processor 400 is configured to initiate a random access procedure in response to, at least in part, the hashed bits matching the locally generated hashed bits. In some examples, the processor 400 is configured to monitor the PDCCH for the second system information in response to receiving a paging message or transmitting an SI request.

In some examples, the processor 400 is configured to start a timer in response to the registration and initiate a re-registration procedure upon expiry of the timer to obtain an updated first set of security parameters.

In some examples, the processor 400 is configured to broadcast first SI of a cell and schedule, via a PDCCH, transmission of second SI of the cell on a PDSCH, wherein at least a portion of the PDCCH transmission and the PDSCH transmission for the second SI is based on parameters derived from a security context shared with registered UE.

In some examples, the processor 400 is configured to scramble a cyclic redundancy check of downlink control information in the PDCCH using bits derived from the security context. In some examples, the processor 400 is configured to scramble channel bits of the PDCCH using a pseudo-random sequence initialized based on the security context.

In some examples, the processor 400 is configured to determine an interleaver for CCE to REG mapping in the PDCCH using bits derived from the security context, wherein a CCE comprises a first number of REGs and a REG comprises a second number of resource elements.

In some examples, the processor 400 is configured to scramble codewords of the PDSCH using parameters derived from the security context. In some examples, the processor 400 is configured to transmit the second SI based on the security context when a paged UE supports decoding using the security context.

In some examples, the processor 400 is configured to transmit the second SI in response to receiving a SI request, wherein resources for SI requests are divided into subsets corresponding to UEs that support or do not support decoding using the security context.

In some examples, the second SI comprises hashed bits of at least one of a random access configuration or a paging configuration, the hashing being based on the security context.

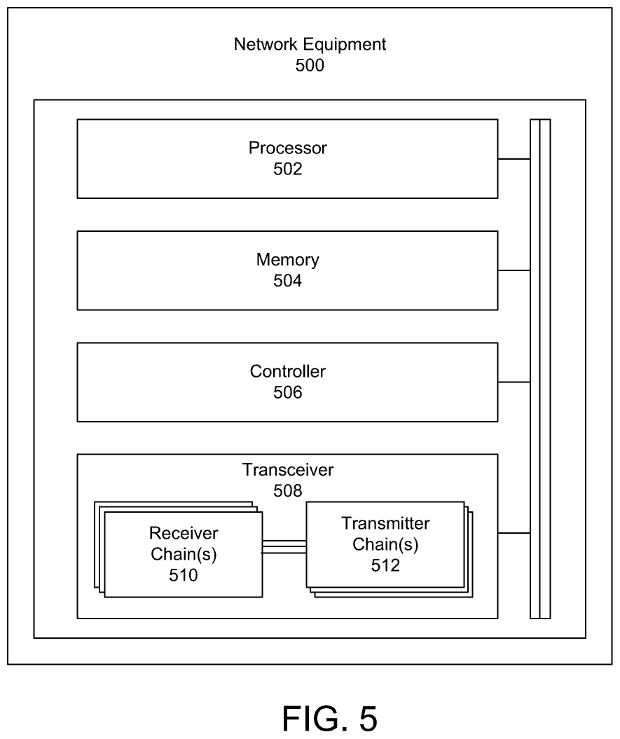

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the RAN functions described herein (e.g., executing, by the processor 502, instructions stored in the memory 504). For example, the processor 502 may support wireless communication at the NE 500 in accordance with examples as disclosed herein.

In some examples, the NE 500 is configured to broadcast first SI of a cell and schedule, via a PDCCH, transmission of second SI of the cell on a PDSCH, wherein at least a portion of the PDCCH transmission and the PDSCH transmission for the second SI is based on parameters derived from a security context shared with registered UE.

In some examples, the NE 500 is configured to scramble a cyclic redundancy check of downlink control information in the PDCCH using bits derived from the security context. In some examples, the NE 500 is configured to scramble channel bits of the PDCCH using a pseudo-random sequence initialized based on the security context.

In some examples, the NE 500 is configured to determine an interleaver for CCE to REG mapping in the PDCCH using bits derived from the security context, wherein a CCE comprises a first number of REGs and a REG comprises a second number of resource elements.

In some examples, the NE 500 is configured to scramble codewords of the PDSCH using parameters derived from the security context. In some examples, the NE 500 is configured to transmit the second SI based on the security context when a paged UE supports decoding using the security context.

In some examples, the NE 500 is configured to transmit the second SI in response to receiving a SI request, wherein resources for SI requests are divided into subsets corresponding to UEs that support or do not support decoding using the security context.

In some examples, the second SI comprises hashed bits of at least one of a random access configuration or a paging configuration, the hashing being based on the security context.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

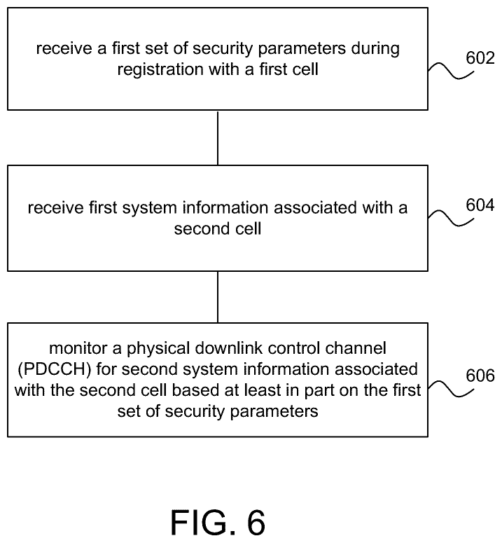

FIG. 6 illustrates a flowchart of a method performed by a UE 300 in accordance with aspects of the present disclosure. The operations of the method may be implemented by a UE 300 as described herein. In some implementations, the UE 300 may execute a set of instructions to control the function elements of the UE 300 to perform the described functions.

At step 602, the method may receive a first set of security parameters during registration with a first cell. The operations of step 602 may be performed in accordance with examples as described herein. In some implementations, aspects of the operations of step 602 may be performed by a UE 300, as described with reference to FIG. 3.

At step 604, the method may receive first SI associated with a second cell. The operations of step 604 may be performed in accordance with examples as described herein. In some implementations, aspects of the operations of step 604 may be performed by a UE 300, as described with reference to FIG. 3.

At step 606, the method may monitor a PDCCH for second SI associated with the second cell based at least in part on the first set of security parameters. The operations of step 606 may be performed in accordance with examples as described herein. In some implementations, aspects of the operations of step 606 may be performed by a UE 300, as described with reference to FIG. 3.

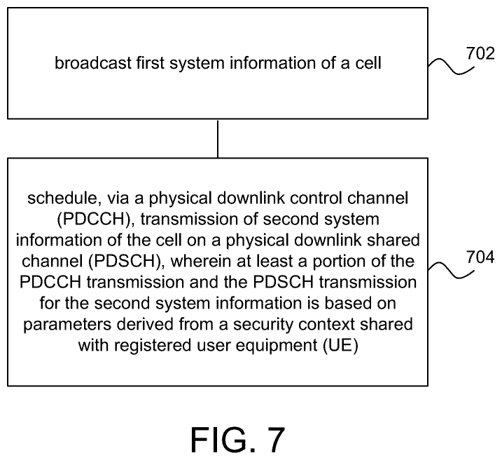

FIG. 7 illustrates a flowchart of a method performed by an NE 500 in accordance with aspects of the present disclosure. The operations of the method may be implemented by a NE 500 as described herein. In some implementations, the NE 500 may execute a set of instructions to control the function elements of the NE 500 to perform the described functions.

At step 702, the method may broadcast first SI of a cell. The operations of step 702 may be performed in accordance with examples as described herein. In some implementations, aspects of the operations of step 702 may be performed by a NE 500, as described with reference to FIG. 5.

At step 704, the method may schedule, via a PDCCH, transmission of second SI of the cell on a PDSCH, wherein at least a portion of the PDCCH transmission and the PDSCH transmission for the second SI is based on parameters derived from a security context shared with registered UE. The operations of step 704 may be performed in accordance with examples as described herein. In some implementations, aspects of the operations of step 704 may be performed by a NE 500, as described with reference to FIG. 5.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first set of security parameters during registration with a first cell;
receive first system information associated with a second cell; and
monitor a physical downlink control channel (PDCCH) for second system information associated with the second cell based at least in part on the first set of security parameters.

2. The UE of claim 1, wherein the at least one processor is configured to cause the UE to:
generate a second set of security parameters based at least in part on the first set of security parameters; and
monitor the PDCCH for the second system information using the second set of security parameters.

3. The UE of claim 2, wherein the at least one processor is configured to cause the UE to generate the second set of security parameters by hashing the first set of security parameters with at least one of a cell identity associated with the second cell, a frequency of a synchronization signal block associated with the second cell, or a system frame number associated with the second cell.

4. The UE of claim 2, wherein the at least one processor is configured to cause the UE to descramble a cyclic redundancy check (CRC) of downlink control information (DCI) for the second system information using at least one of the second set of security parameters.

5. The UE of claim 2, wherein the at least one processor is configured to cause the UE to monitor a PDCCH according to an interleaver for control channel element (CCE) to resource element group (REG) mapping, the interleaver being determined using at least one of the second set of security parameters, wherein a CCE comprises a first number of REGs and a REG comprises a second number of resource elements.

6. The UE of claim 2, wherein the at least one processor is configured to cause the UE to receive a physical downlink shared channel (PDSCH) for the second system information, the PDSCH comprising codewords that have been scrambled based on at least one of the second set of security parameters and descramble the codewords based on the at least one of the second set of security parameters.

7. The UE of claim 1, wherein the second system information comprises hashed bits of a random access configuration or paging configuration, and the at least one processor is configured to cause the UE to verify an integrity of the first system information by comparing the hashed bits with locally generated hashed bits.

8. The UE of claim 7, wherein the at least one processor is configured to cause the UE to initiate a random access procedure in response to, at least in part, the hashed bits matching the locally generated hashed bits.

9. The UE of claim 1, wherein the at least one processor is configured to cause the UE to monitor the PDCCH for the second system information in response to receiving a paging message or transmitting a system information request.

10. The UE of claim 1, wherein the at least one processor is configured to cause the UE to start a timer in response to the registration and initiate a re-registration procedure upon expiry of the timer to obtain an updated first set of security parameters.

11. A method of a user equipment (UE), comprising:
receiving a first set of security parameters during registration with a first cell;
receiving first system information associated with a second cell; and
monitoring a physical downlink control channel (PDCCH) for second system information associated with the second cell based at least in part on the first set of security parameters.

12. A network equipment (NE) for wireless communication, comprising:
at least one memory; and
at least one processor coupled with the at least one memory and configured to cause the NE to:
broadcast first system information of a cell; and
schedule, via a physical downlink control channel (PDCCH), transmission of second system information of the cell on a physical downlink shared channel (PDSCH), wherein at least a portion of the PDCCH transmission and the PDSCH transmission for the second system information is based on parameters derived from a security context shared with registered user equipment (UE).

13. The NE of claim 12, wherein the at least one processor is configured to cause the NE to scramble a cyclic redundancy check (CRC) of downlink control information (DCI) in the PDCCH using bits derived from the security context.

14. The NE of claim 12, wherein the at least one processor is configured to cause the NE to scramble channel bits of the PDCCH using a pseudo-random sequence initialized based on the security context.

15. The NE of claim 12, wherein the at least one processor is configured to cause the NE to determine an interleaver for control channel element (CCE) to resource element group (REG) mapping in the PDCCH using bits derived from the security context, wherein a CCE comprises a first number of REGs and a REG comprises a second number of resource elements.

16. The NE of claim 12, wherein the at least one processor is configured to cause the NE to scramble codewords of the PDSCH using parameters derived from the security context.

17. The NE of claim 12, wherein the at least one processor is configured to cause the NE to transmit the second system information based on the security context when a paged UE supports decoding using the security context.

18. The NE of claim 12, wherein the at least one processor is configured to cause the NE to transmit the second system information in response to receiving a system information request, wherein resources for system information requests are divided into subsets corresponding to UEs that support or do not support decoding using the security context.

19. The NE of claim 12, wherein the second system information comprises hashed bits of at least one of a random access configuration or a paging configuration, the hashing being based on the security context.

20. A method of a network equipment (NE), comprising:
broadcasting first system information of a cell; and
scheduling, via a physical downlink control channel (PDCCH), transmission of second system information of the cell on a physical downlink shared channel (PDSCH), wherein at least a portion of the PDCCH transmission and the PDSCH transmission for the second system information is based on parameters derived from a security context shared with registered user equipment (UE).
